(19) United States
(12) Patent Application Publication
(10) Pub. No.: US 2017/0366881 A1
(43) Pub. Date: Dec. 21, 2017

(54) Scalable Secure Hybrid Electrical-Optical Switched Network with Optical Wavelength Tunable Transceivers

(71) Applicant: Chien-Yu Kuo, Cupertino, CA (US)

(72) Inventor: Chien-Yu Kuo, Cupertino, CA (US)

(21) Appl. No.: 15/625,992

(22) Filed: Jun. 16, 2017

Related U.S. Application Data
(60) Provisional application No. 62/350,910, filed on Jun. 16, 2016.

(51) Int. Cl. H04Q 11/00; H04B 10/572; H04J 14/02

(52) U.S. Cl. CPC H04Q 11/0005; H04J 14/02; H04B 10/572; H04Q 2011/0015; H04Q 2011/0018; H04Q 2011/0037; H04Q 2011/0016

(57) ABSTRACT

A method for creating a hybrid electric and optical data center network is provided with a plurality of servers, a plurality of ToR/EoR switches, and an optical central switch. Each of the plurality servers maintains an electronic connection with a corresponding ToR/EoR switch from the plurality of switches. The plurality of ToR/EoR switches is interconnected to each other electronically and optically. The optical central switch in conjunction with a plurality of tunable transceivers allows a signal originating from any of the plurality of the servers, to traverse the data center network to reach any destination server. To do so, wavelength switching takes place via the plurality of transceivers at each of the ToR/EoR switches. Simultaneously, space switching takes place within the center switch. By utilizing the method, intra data center bandwidth is optimized and the network the method is utilized in is non-blocking.

The current application claims a priority to the U.S. Provisional Patent application Ser. No. 62/350,910 filed on Jun. 16, 2016.

### FIELD OF THE INVENTION

The present invention relates generally to a method of creating a centralized optical switch network. More specifically, the present invention creates a hybrid electric and optical data center network that utilizes the optical wavelength tunability of the optical transceivers to adapt the network topology and link capacities for changing traffic a variety of traffic demands.

### BACKGROUND OF THE INVENTION

Currently, optical fiber is a major part of the communication infrastructures, be it the telecommunication networks, cable networks, or data center networks. The key requirement is the high bandwidth and the ability to communicate from one end of the network to the other end of the network with proper switching. This invention description is for the data centers applications, but the architecture is equally applicable to telecommunication and cable networks.

As the data centers become more modular and larger in sizes, they require higher aggregation or larger switches. Subsequently, the traffic become more stable/steady in addition to the usual bursty traffic. Using purely electrical packet switches to route the traffic and maintain the high bandwidth needed to reduce the over subscription becomes unnecessarily costly. As such, with proper traffic engineering, it is a lot more reasonable to route the traffic with more stable nature through circuit switches whereas the bursty traffic can stay in the packet switching part of the network.

A typical data center infrastructure consists of at least three levels of equipment. On the access level are the massive servers serving the function of calculation and storage. The servers are usually housed in racks or rows of racks. These servers are the hosts feeding the Top of the Rack (ToR) switches or End of Row (EoR) switches that perform the switching function as well as aggregate these servers and connect to higher level aggregators through copper and fiber networks. These aggregators then connect to core switches with optical transceivers before going across the outside connection demarcation and emanating from the data centers and traverse the telecommunication network and cloud to its destination. To facilitate effective communication and services inside the data center, data needs to be moved from server to server, rack to rack, aggregators to aggregators. As such, there exist the switches need to provide these functionalities in an as little blocking as possible fashion while utilizing the machines effectively with largest possible bandwidths.

### BRIEF DESCRIPTION OF THE DRAWINGS

FIG. 1A is a flowchart illustrating the basic overall process of the present invention.

FIG. 1B is an illustration of the present invention being used within data center architecture.

FIG. 2 is an illustration of the optical central switch being used with the plurality of ToR/EoR switches.

FIG. 3 is an illustration of the outgoing assembly.

FIG. 4 is an illustration of the incoming assembly.

FIG. 5 is an illustration of the optical central switch.

FIG. 6 is an illustration of one of the plurality of space switches.

FIG. 7 is an illustration of the tunable optical filter being used with the present invention.

### DETAIL DESCRIPTIONS OF THE INVENTION

All illustrations of the drawings are for the purpose of describing selected versions of the present invention and are not intended to limit the scope of the present invention.

The present invention introduces a method for creating a hybrid electrical and optical network to maximize efficiency and affect non-blocking traffic within a data center. In order to maximize efficiency and affect non-blocking traffic, the present invention uses electrical switches and a wavelength switching within tunable transceivers in conjunction with a software defined network to effectively direct the traffic within a data center. The present invention provides significant saving on capital expenditure, operational expenditure, and power consumption in the constantly growing data centers. Moreover, the present invention maximizes intra data center bandwidth, minimizes packet switching blockages, and promotes non-blocking optical switching.

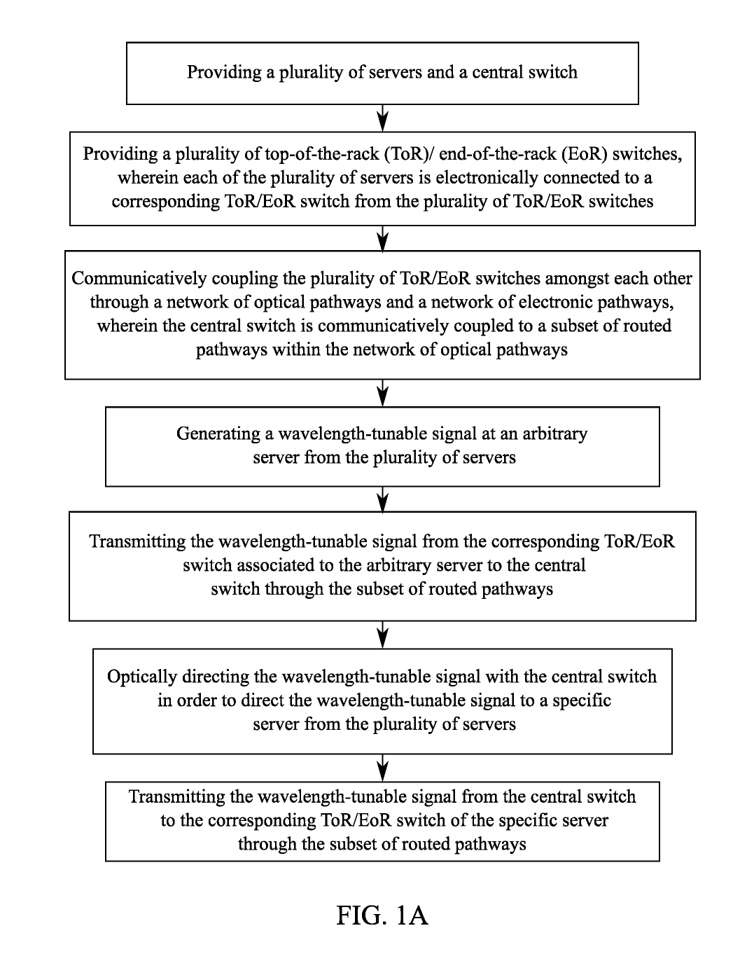

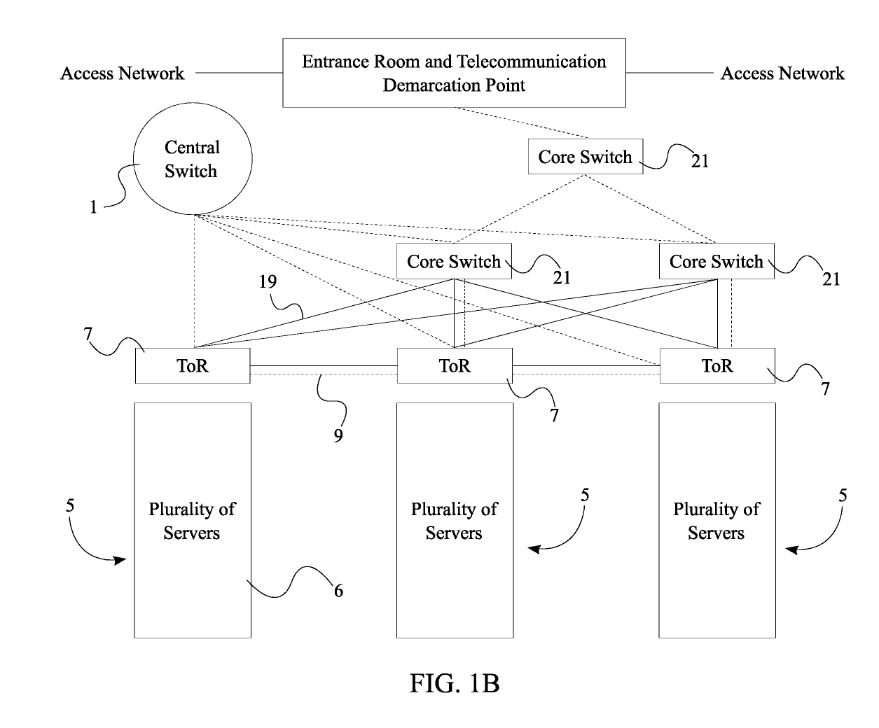

As illustrated in FIG. 1A and FIG. 1B, to maximize efficiency and affect non-blocking traffic, the present invention is provided with a plurality of servers 5, a plurality of top-of-the-rack (ToR)/end-of-the-row (EoR) switches 7, and an optical central switch 1. The plurality of servers 5 and the plurality of ToR/EoR switches 7 are interconnected such that each of the plurality of servers 5 is electronically connected to a corresponding ToR/EoR switch from the plurality of ToR/EoR switches 7. To direct traffic from one server to another server of the plurality of servers 5, the plurality of ToR/EoR switches 7 is communicatively coupled amongst each other through a network of electronic pathways 19 or a network of optical pathways 9. To do so, the optical central switch 1 is communicatively coupled to a subset of routable optical pathways 10 within the network of optical pathways 9. The remaining pathways in the network of optical pathways 9 and the network of electronic pathways 19, which are outside the subset of routable optical pathways, are communicatively coupled through a plurality of core and aggregator switches. However, the optical central switch 1 and the subset of routable optical pathways 10 enable a wavelength-tunable signal to reach its intended destination via the most optimal path. More specifically, when a wavelength-tunable signal is generated at an arbitrary server 6 from the plurality of servers 5, the corresponding ToR/EoR switch associated to the arbitrary server 6 transmits the wavelength-tunable signal to the optical central switch 1 through the subset of routable optical pathways 10. Upon receiving the wavelength-tunable signal, the optical central switch 1 optically directs the wavelength-tunable signal in order to direct the wavelength-tunable signal to a specific server from the plurality of servers 5. In doing so, the wavelength-tunable signal is transmitted from the optical central switch 1 to the corresponding ToR/EoR switch of the specific server through the subset of routable optical pathways 10.

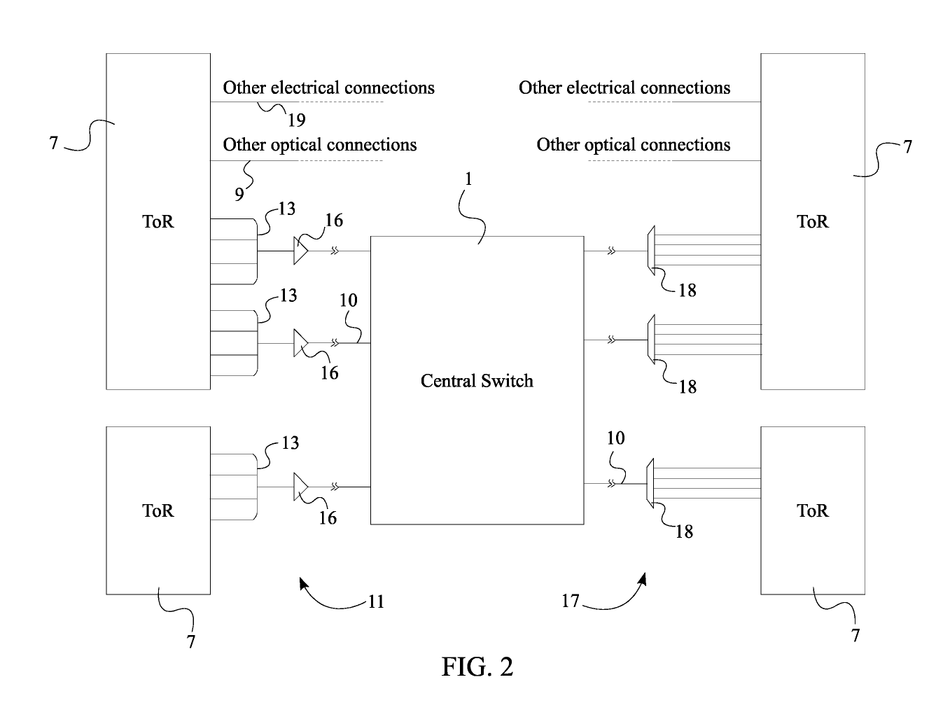

As illustrated in FIG. 2, to execute wavelength switching, the present invention provides at least one outgoing assembly 11 for each optical routed pathway. The outgoing assembly 11 includes a plurality of transceivers 12 and a combiner 13 that is used simultaneously for wavelength switching purposes. More specifically, the wavelength-tunable signal is generated with the plurality of transceivers 12 and is multiplexed with the combiner 13 before being transmitted to the optical central switch 1 via the subset of routable optical pathways 10.

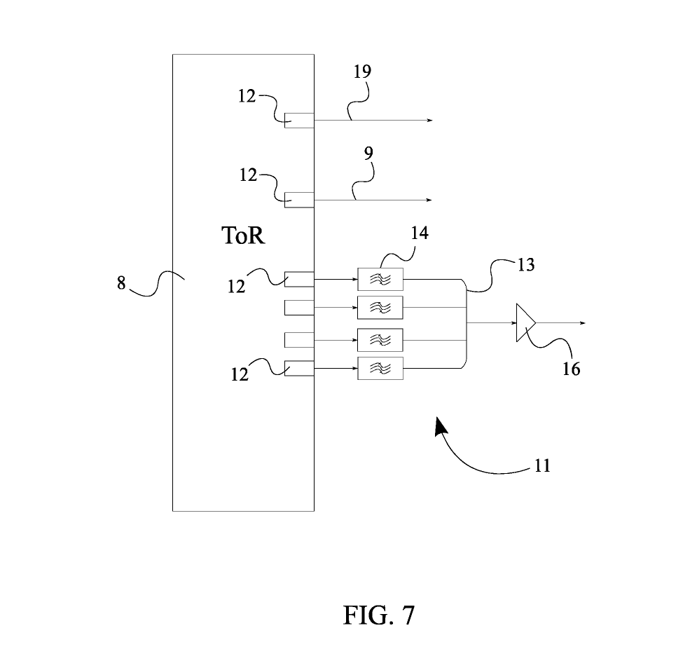

As illustrated in FIG. 7, to significantly reduce relative intensity noise (RIN) from the wavelength-tunable signal, the present invention is provided with a tunable optical filter 14 for the outgoing assembly 11. The tunable optical filter 14 modifies the wavelength-tunable signal before transmitting the wavelength-tunable signal to the optical central switch 1. Thus, the noise in the combined wavelength-tunable signal is minimized. The tunable optical filter 14 can be integrated into the outgoing assembly 11 differently in varying embodiments of the present invention. As an example, the tunable optical filter 14 can be integrated at an input port of the combiner 13.

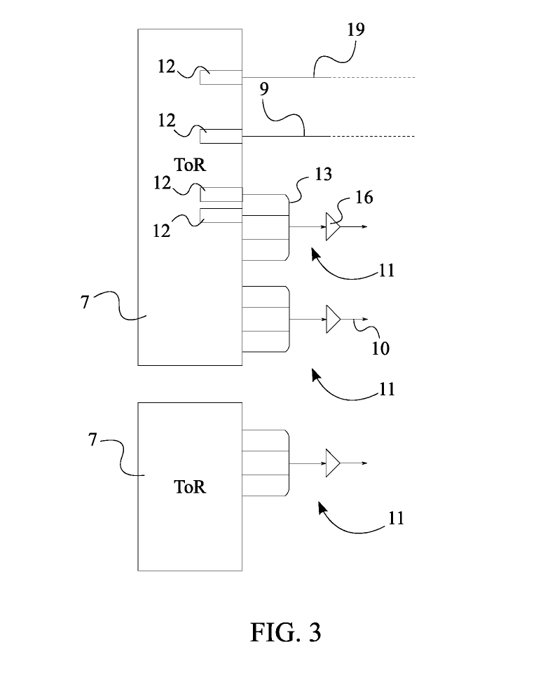

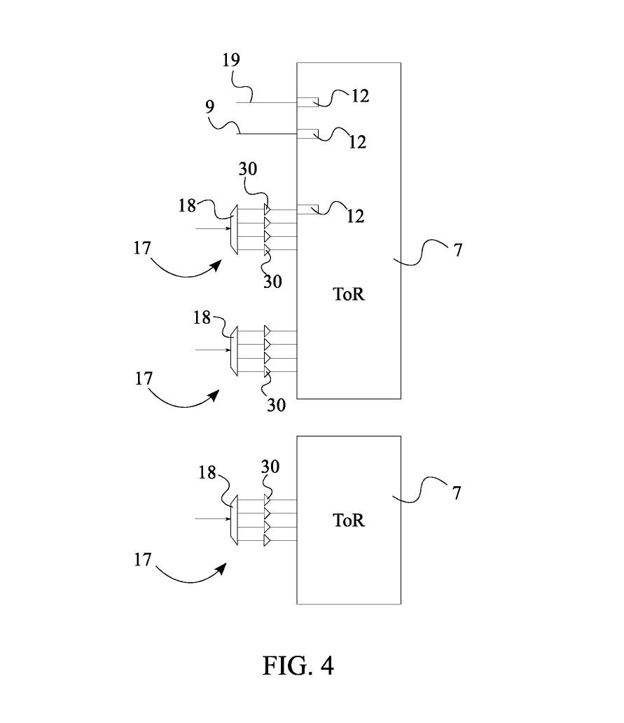

As illustrated in FIG. 3 and FIG. 4, different kinds of transceiver can be electronically integrated into each of the plurality of ToR/EoR switches 7. Thus, when the present invention is provided an optional electrical transceiver, the optional electrical transceiver is communicably coupled to the network of electronic pathways 19. As an example, the optional electrical transceiver can be used to connected to the plurality of core and aggregator switches 21. When the present invention is provided with an optional non-wavelength specific transceiver for each of the plurality of ToR/EoR switches 7, the optional non-wavelength specific transceiver is communicably coupled to the network of optical pathways 9, outside of the subset of routable optical pathways 10. Thus, the optional non-wavelength specific transceiver can be used for optical signals that are not routed through the optical central switch 1. When the present invention is provided with an optional fixed wavelength transceiver for each of the plurality of ToR/EoR switches 7, the optional fixed wavelength transceiver is communicably coupled to the subset of routable optical pathways. However, the optional fixed wavelength transceiver can also be communicably coupled to the network of optical pathways 9, outside of the subset of routable optical pathways 10. In the preferred embodiment of the present invention, the optional fixed wavelength transceiver is a dense wavelength division multiplexing (DWDM) grid. When the present invention is provided with at least one tunable wavelength transceiver for each of the plurality of ToR/EoR switches 7, the at least one tunable wavelength transceiver is communicably coupled to the subset of routable optical pathways 10. The wavelength tunability allows the wavelength-tunable signal to originate from any of the plurality of ToR/EoR switches 7 and allows the wavelength-tunable signal to be directed to any of the plurality of ToR/EoR switches 7. Data collisions are avoided by utilizing the wavelength tunability of the present invention.

As mentioned earlier, when being combined into a single fiber with the use of the combiner 13, the wavelength-tunable signal can encounter a notable optical loss. To address the optical loss, the outgoing assembly 11 for each optical routed pathway includes an optical amplifier 16 as seen in FIG. 3 and FIG. 4. By utilizing the optical amplifier 16, the wavelength-tunable signal is amplified before being transmitted to the optical central switch 1. In the preferred embodiment of the present invention, the optical amplifier 16 is an Erbium-doped fiber amplifier (EDFA). The EDFA is used since the wavelengths associated with the present invention are in the C band and the L band. However, other optical amplifiers can be used in different embodiments of the present invention when different wavelengths are involved.

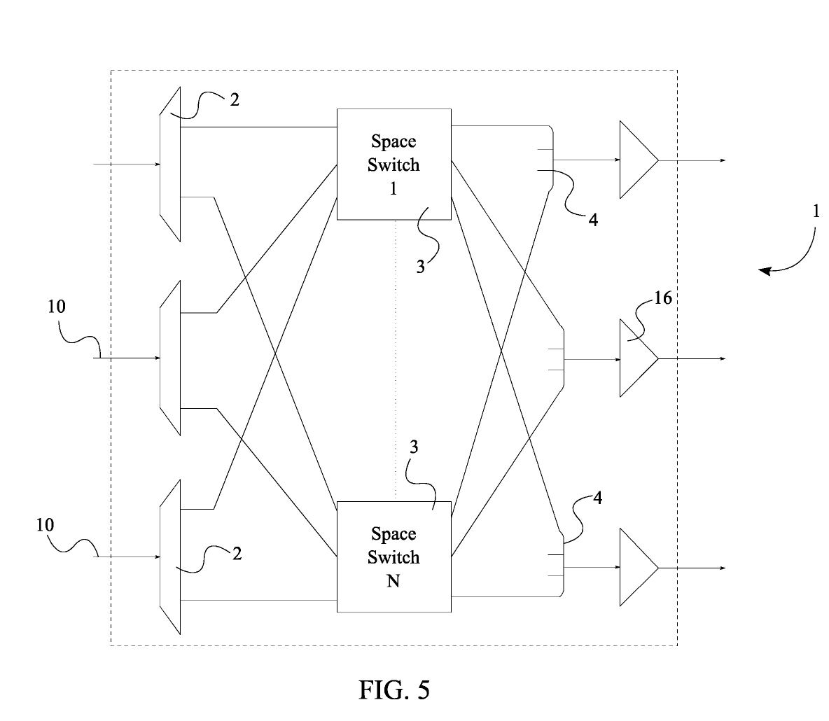

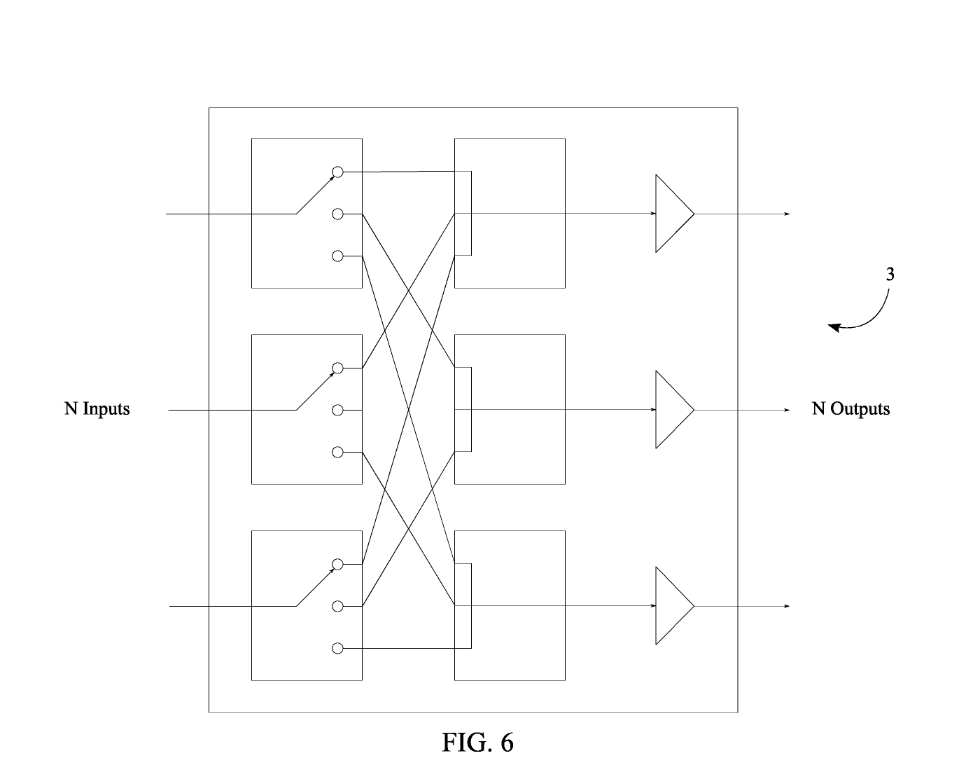

The space switching portion of the present invention is executed as part of the optical central switch 1. As seen in FIG. 5 and FIG. 6, the present invention is provided with a plurality of internal demultiplexers 2, a plurality of space switches 3, and a plurality of internal combiners 4 for the optical central switch 1. Furthermore, the plurality of internal demultiplexers 2 is communicatively coupled with each of the plurality of space switches 3, and each of the plurality of space switches 3 is communicatively coupled with each of the plurality of internal combiners 4. Moreover, each of the plurality of space switches 3 includes an equal number of inputs and outputs. For instance, if the optical central switch 1 consists of a K-number of inputs, the optical central switch 1 will have a K-number of outputs so that the optical central switch 1 is a K×K switch. The wavelength-tunable signal is received with an arbitrary internal demultiplexer from the plurality of internal demultiplexers 2. The arbitrary internal demultiplexer is associated to the arbitrary server 6 that generated the wavelength-tunable signal. Upon receiving the wavelength-tunable signal at the plurality of internal demultiplexers 2, the wavelength-tunable signal is routed from the arbitrary internal demultiplexer through a specific space switch from the plurality of space switches 3. The specific space switch is determined by the network management software that is used with the present invention. More specifically, the traffic orchestration of the network management software determines the specific space switch. Upon routing to the least traffic-burdened switch, the present invention routes the wavelength-tunable signal from the least traffic-burdened switch to a specific internal combiner, wherein the specific internal combiner is associated to the specific server. Each output is associated with an internal combiner of the plurality of internal combiners 4. Thus, in a K×K switch, the plurality of internal combiners 4 consists of a K-number of internal combiners.

For the wavelength-specific signal to reach the specific server, the present invention is provided with at least one incoming assembly 17 for each optical routed pathway. To execute the process of transmitting the wavelength-tunable signal to the specific server, the incoming assembly 17 includes an incoming demultiplexer 18 and a plurality of transceivers 12. The wavelength-tunable signal is demultiplexed with the incoming demultiplexer 18. Next, the wavelength-tunable signal is received with the use of the plurality of transceivers 12 so that the wavelength-tunable signal reaches the specific server. The present invention provides a pre-optical amplifier 30 for each of the plurality of transceivers 12 so that the wavelength-tunable amplifier can be amplified before the wavelength-tunable signal is received by the plurality of transceivers 12.

The tunability of the present invention enables software defined network (SDN) and network function virtualization (NFV) orchestration. More specifically, the present invention eliminates the need to closely monitor traffic patterns and alter software and hardware for efficiency. The present invention also provides transparent integration between the electrical packet switching and optical packet switching. To do so, the present invention directs traffic by considering switching time and buffering the traffic according to the switching time. Thus, no data loss occurs during the optical or electric switching.

The present invention can be used to establish optimal and flexible network communication internal to data centers with linearly scalable switches. To do so, the present invention combines electrical packet switching and optical circuit switching to obtain a conceptually non-blocking network. Moreover, the present invention enhances network security on the wavelength level so that the cost of securing is also reduced.

Although the invention has been explained in relation to its preferred embodiment, it is to be understood that many other possible modifications and variations can be made without departing from the spirit and scope of the invention as hereinafter claimed.

What is claimed is:

1. A method for creating a hybrid electric and optical data center network, the method comprises the steps of:
providing a plurality of servers and an optical central switch;
providing a plurality of top-of-the-rack (ToR)/end-of-the-rack (EoR) switches, wherein each of the plurality of servers is electronically connected to a corresponding ToR/EoR switch from the plurality of ToR/EoR switches;
communicatively coupling the plurality of ToR/EoR switches amongst each other through a network of optical pathways and a network of electronic pathways, wherein the optical central switch is communicatively coupled to a subset of routable optical pathways within the network of optical pathways;
generating a wavelength-tunable signal at an arbitrary server from the plurality of servers;
transmitting the wavelength-tunable signal from the corresponding ToR/EoR switch associated to the arbitrary server to the optical central switch through the subset of routable optical pathways;
optically directing the wavelength-tunable signal with the optical central switch in order to direct the wavelength-tunable signal to a specific server from the plurality of servers; and
transmitting the wavelength-tunable signal from the optical central switch to the corresponding ToR/EoR switch of the specific server through the subset of routable optical pathways.

2. The method for creating a hybrid electric and optical data center network, the method as claimed in claim 1 further comprises the steps of:
providing at least one outgoing assembly for each optical routed pathway, wherein the outgoing assembly includes a plurality of transceivers and a combiner;
generating the wavelength-tunable signal with the plurality of transceivers; and
multiplexing the wavelength-tunable signal with the combiner before transmitting the wavelength-tunable signal to the optical central switch.

3. The method for creating a hybrid electric and optical data center network, the method as claimed in claim 2 further comprises the steps of:
providing a tunable optical filter for the outgoing assembly; and
modifying the wavelength-tunable signal with the tunable optical filter before transmitting the wavelength-tunable signal to the optical central switch.

4. The method for creating a hybrid electric and optical data center network, the method as claimed in claim 1 further comprises the steps of:
providing an optional electrical transceiver for each of the plurality of ToR/EoR switches; and
communicably coupling the optional electrical transceiver to the network of electrical pathways.

5. The method for creating a hybrid electric and optical data center network, the method as claimed in claim 1 further comprises the steps of:
providing an optional non-wavelength specific transceiver for each of the plurality of ToR/EoR switches; and
communicably coupling the optional non-wavelength specific transceiver to the network of optical pathways, outside of the subset of routable optical pathways.

6. The method for creating a hybrid electric and optical data center network, the method as claimed in claim 1 further comprises the steps of:
providing an optional fixed wavelength transceiver for each of the plurality of ToR/EoR switches; and
communicably coupling the optional fixed wavelength transceiver to the subset of routable optical pathways.

7. The method for creating a hybrid electric and optical data center network, the method as claimed in claim 8, wherein the optional fixed wavelength transceiver is a dense wavelength division multiplexing (DWDM) grid.

8. The method for creating a hybrid electric and optical data center network, the method as claimed in claim 1 further comprises the steps of:
providing optional fixed wavelength transceiver for each of the plurality of ToR/EoR switches; and
communicably coupling the optional fixed wavelength transceiver to the network of optical pathways, outside of the subset of routable optical pathways.

9. The method for creating a hybrid electric and optical data center network, the method as claimed in claim 10, wherein the optional fixed wavelength transceiver is a dense wavelength division multiplexing (DWDM) grid.

10. The method for creating a hybrid electric and optical data center network, the method as claimed in claim 1 further comprises the steps of:
providing at least one tunable wavelength transceiver for each of the plurality of ToR/EoR switches; and
communicably coupling the at least one tunable wavelength transceiver to the subset of routable optical pathways.

11. The method for creating a hybrid electric and optical data center network, the method as claimed in claim 1 further comprises the steps of:
providing at least one outgoing assembly for each optical routed pathway, wherein the outgoing assembly includes an optical amplifier; and
amplifying the wavelength-tunable signal with the optical amplifier before transmitting the wavelength-tunable signal to the optical central switch.

12. The method for creating a hybrid electric and optical data center network, the method as claimed in claim 11, wherein the optical amplifier is an Erbium-doped fiber amplifier (EDFA).

13. The method for creating a hybrid electric and optical data center network, the method as claimed in claim 1 further comprises the steps of:
providing a plurality of internal demultiplexers, a plurality of space switches, and a plurality of internal combiners for the optical central switch, wherein each of the plurality of internal demultiplexers is communicatively coupled with each of the plurality of space switches, and wherein each of the plurality of space switches is communicatively coupled with each of the plurality of internal combiners;
receiving the wavelength-tunable signal with an arbitrary internal demultiplexer from the plurality of internal demultiplexers, wherein the arbitrary internal demultiplexer is associated to the arbitrary server;
routing the wavelength-tunable signal from the arbitrary internal demlutiplexer through a least traffic-burdened switch from the plurality of space switches; and
routing the wavelength-tunable signal from the least traffic-burdened switch to a specific internal combiner, wherein the specific internal combiner is associated to the specific server.

14. The method for creating a hybrid electric and optical data center network, the method as claimed in claim 13, wherein each of the plurality of space switches includes an equal number of inputs and outputs.

15. The method for creating a hybrid electric and optical data center network, the method as claimed in claim 1 further comprises the steps of:
providing at least one incoming assembly for each optical routed pathway, wherein the incoming assembly includes an incoming demultiplexer and a plurality of transceivers;
demultiplexing the wavelength-tunable signal with the incoming demultiplexer; and
distributing the wavelength-tunable signal to the plurality of transceivers.

16. The method for creating a hybrid electric and optical data center network, the method as claimed in claim 15 further comprises the steps of:
providing an optical amplifier for each of the plurality of transceivers; and
amplifying the wavelength-tunable signal with the optical amplifier before receiving the wavelength-tunable signal with the plurality of transceivers.
